(19) United States
(12) Patent Application Publication
(10) Pub. No.: US 2015/0131010 A1
(43) Pub. Date: May 14, 2015

(54) TOUCH PANEL DEVICE

(71) Applicant: SHARP KABUSHIKI KAISHA, Osaka (JP)

(72) Inventor: Koichi SUGIYAMA, Osaka (JP)

(21) Appl. No.: 14/534,316

(22) Filed: Nov. 6, 2014

(30) Foreign Application Priority Data
Nov. 12, 2013 (JP) 2013-234282

(51) Int. Cl. G06F 3/042; G06F 1/16; G06F 3/041

(52) U.S. Cl. CPC G06F 3/0421; G06F 3/0412; G06F 1/1601
USPC 349/12

(57) ABSTRACT

In a touch panel device which comprises a display panel displaying an image, an array of light emitting devices that emit light along a display screen of the display panel, and an array of light receiving devices disposed opposite to the array of light emitting devices, the light receiving devices receiving light from the light emitting devices, and which detects a position of a light blocking object which shields light from the light emitting devices on the display screen, an antireflection part is provided which prevents light emitted from the light emitting devices and directed to a holding member covering a border of the display screen and holding the display panel from being reflected in a direction along the display screen.

### CROSS-REFERENCE TO RELATED APPLICATIONS

This Nonprovisional application claims priority under 35 U.S.C. §119(a) on Patent Application No. 2013-234282 filed in Japan on Nov. 12, 2013, the entire contents of which are hereby incorporated by reference.

### FIELD

The present invention relates to a touch panel device which comprises a display panel displaying an image, an array of light emitting devices emitting light along a display screen of the display panel and an array of light receiving devices positioned opposite to the array of the light emitting devices, the light receiving devices receiving the light emitted from the light emitting devices, and which detects a position of a light blocking object that shields the light emitted from the light emitting devices on the display screen.

### BACKGROUND ART

In recent years, an electronic whiteboard has been become widely used, which is able to detect coordinates relating to information written on a display screen and overwrite the information on an image displayed on the display screen so that the image and the written information are displayed overlapping with each other, or to incorporate the written information into a computer in real time and display the information written on the display screen.

As a method for inputting or detecting coordinates used in the electronic whiteboard, various types of methods have been proposed. One of the proposed methods is an infrared ray blocking method using infrared ray. FIG. 16 is a diagram illustrating coordinate detection and coordinate input in a conventional electronic whiteboard of an infrared ray blocking type.

According to an electronic whiteboard 200 of such an infrared ray blocking type, a number of LEDs 1, 2, 3 . . . emitting infrared ray are arranged with evenly spaced in an array disposed on one side in a vertical direction (not illustrated) and one side in a horizontal direction of a display panel 201, and opposite to each of the arrays of the LEDS, light receiving devices 1, 2, 3 . . . (photo transistors) are arranged in an array with the same spaces as the LEDs. Then, pairs of the LEDs and light receiving devices opposing each other are sequentially scanned in order to detect if infrared ray light is blocked due to the presence of a light blocking object in the X direction (horizontal direction) and the Y direction (vertical direction), and to recognize the position of the light blocking object as an input position.

For example, when light of infrared ray (hereinafter, simply referred to as infrared light) emitted from an LED 3 is shielded by a light blocking object S, the amount of light received by the light receiving device 1 to the light receiving device 5 is decreased. In accordance with the variation in the amount of light received by the light receiving devices 1, 2, 3 . . . , the presence and the position (coordinates) of the light blocking object S can be detected.

On the other hand, Japanese Patent Application Laid-Open No. 2000-20227 discloses a touch panel of an infrared ray blocking type which preliminarily divides a distance between each of the arranged light emitting devices and light receiving devices by a predetermined number and outputs high resolution coordinate based on positional coordinates obtained, and also concentrically scans only around the coordinates of a light blocking object detected at an arbitrary position on a display screen.

### SUMMARY

However, in the conventional electronic whiteboard 200 as described above, there is a problem that a false detection of a light blocking object S occurs due to light reflection by a holding member that holds a display panel 201. Such reflection light is referred to as undesired reflection light in FIG. 16. Details thereof are described later.

FIG. 17 is a cross-sectional view taken from line I-II of FIG. 16.

The electronic whiteboard 200 includes a display screen 2010 of the display panel 201, a cover glass 2011 placed at a front side of the display screen 2010, and a bezel part 800 circumferentially provided at an border side of the display screen 2010. The cover glass 2011 and the display panel 201 are held at their positions by a holding member 700.

Also, light emitting devices (or light receiving devices) and a substrate on which the light emitting devices (or the light receiving devices) are mounted are disposed in a position which is inside the bezel part 800 and between the holding member 700 and the bezel part 800. The light emitting devices (or the light receiving devices) are covered with a transparent board 810 extending from a border of the display screen 2010 (cover glass 2011) to an end portion of the bezel part 800.

In the electronic whiteboard 200 having such a configuration, infrared light emitted from the light emitting device is outputted through the transparent board 810 and enters the light receiving device through a light transparent board 810 at the opposite side.

However, in a case where the electronic whiteboard 200 is large-sized and is installed upright in such a manner that the display screen 2010 is vertical with respect to the installation surface such as a floor, a gap may be generated between the transparent board 810 and the cover glass 2011 (display screen 2010) because the display screen 2010 and the cover glass 2011 are deformed by their own weights, or due to a margin of error in a mechanism design or manufacturing.

When a gap is generated as described above, infrared light from the light emitting device LEDs 1, 2 in FIG. 16 travels through the gap in the right side of the bezel, hits on the holding member 700 and is reflected, thereby affecting the light receiving devices 1, 2. Hereinafter, infrared light reflected by the holding member 700 through the gap is referred to as undesired reflection light.

Such undesired reflection light is so-called stray light. When the stray light travels in an unexpected direction and is received by a light receiving device in the direction, it may cause a false detection (light shielding failure) of a light blocking object S.

The present invention is made in view of the above circumstances. An object of the present invention is to provide a touch panel device which comprises a display panel displaying an image, an array of light emitting devices emitting light along a display screen of the display panel, and an array of light receiving devices disposed opposite to the array of light emitting devices, the light receiving devices receiving light from the light emitting devices, and detects a position of a light blocking object which shields light from the light emitting devices on the display screen, the touch panel device further comprising a holding member which covers a border of the display screen, and holds the display panel, wherein the holding member is provided with an antireflection part which prevents light emitted from the light emitting devices from being reflected in a direction along the display screen, thereby avoiding a false detection of the position of a light blocking object on the display screen.

A touch panel device according to the present invention comprises a display panel displaying an image, an array of light emitting devices emitting light along a display screen of the display panel, and an array of light receiving devices disposed opposite to the array of light emitting devices, the light receiving devices receiving light from the light emitting devices, and detects a position of a light blocking object which shields light from the light emitting devices on the display screen, comprising a holding member which covers a border of the display screen, and holds the display panel, wherein the holding member is provided with an antireflection part which suppresses light emitted from the light emitting devices being reflected and received by the light receiving devices.

The touch panel device according to the present invention, wherein the holding member includes a light absorption film which absorbs light emitted from the light emitting devices.

The touch panel device according to the present invention, wherein the holding member is provided with the light absorption film at a portion irradiated with light emitted from the light emitting devices.

The touch panel device according to the present invention, wherein a light absorption sheet which absorbs light is provided on an end portion of the holding member at the display screen side and at a display screen around the end portion.

The touch panel device according to the present invention, wherein the holding member is provided with a light absorption sheet which absorbs light at a portion irradiated with light emitted from the light emitting devices.

The touch panel device according to the present invention, wherein a slant plane forming an obtuse angle with respect to the display screen is formed at a portion of the holding member irradiated with light emitted from the light emitting devices.

According to the present invention, a false detection of the position of a light blocking object on the display screen can be avoided by preventing light emitted from the light emitting device and directed to the holding member from being reflected in a direction along the display screen.

The above and further objects and features will more fully be apparent from the following detailed description with accompanying drawings.

### BRIEF DESCRIPTION OF DRAWINGS

FIG. 1 is a conceptual diagram conceptually illustrating an electronic whiteboard according to Embodiment 1 of the present invention;

FIG. 2 is a functional block diagram illustrating a main configuration of the electronic whiteboard according to Embodiment 1 of the present invention;

FIG. 3 is a functional block diagram illustrating a main configuration of a control part in a touch panel part of the electronic whiteboard according to Embodiment 1 of the present invention;

FIG. 4 is a functional block diagram illustrating a process of light scanning in the electronic whiteboard 100 according to Embodiment 1 of the present invention;

FIG. 5 is an explanatory view illustrating scanning and detection of a light blocking object in the electronic whiteboard according to Embodiment 1 of the present invention;

FIG. 6 is a cross sectional view taken from line A-B of FIG. 1;

FIG. 7 is an explanatory view illustrating Modification 1 of a configuration of an antireflection part in the electronic whiteboard according to Embodiment 1 of the present invention;

FIG. 8 is an explanatory view illustrating Modification 2 of a configuration of an antireflection part in the electronic whiteboard according to Embodiment 1 of the present invention;

FIG. 9 is an explanatory view illustrating Modification 3 of a configuration of an antireflection part in the electronic whiteboard according to Embodiment 1 of the present invention;

FIG. 10 is an explanatory view illustrating a configuration of an antireflection part in an electronic whiteboard according to Embodiment 2 of the present invention;

FIG. 11 is an explanatory view illustrating a modification of a configuration of an antireflection part in an electronic whiteboard according to Embodiment 2 of the present invention;

FIG. 12 is an explanatory view illustrating a configuration of an antireflection part in an electronic whiteboard according to Embodiment 3 of the present invention;

FIG. 13 is an explanatory view illustrating a configuration of an antireflection part in an electronic whiteboard according to Embodiment 4 of the present invention;

FIG. 14 is an explanatory view illustrating a configuration of an antireflection part in an electronic whiteboard according to Embodiment 5 of the present invention;

FIG. 15 is an explanatory view illustrating a configuration of an antireflection part in an electronic whiteboard according to Embodiment 6 of the present invention;

FIG. 16 is a diagram illustrating a coordinate detection and coordinate input in a conventional electronic whiteboard of an infrared ray blocking type;

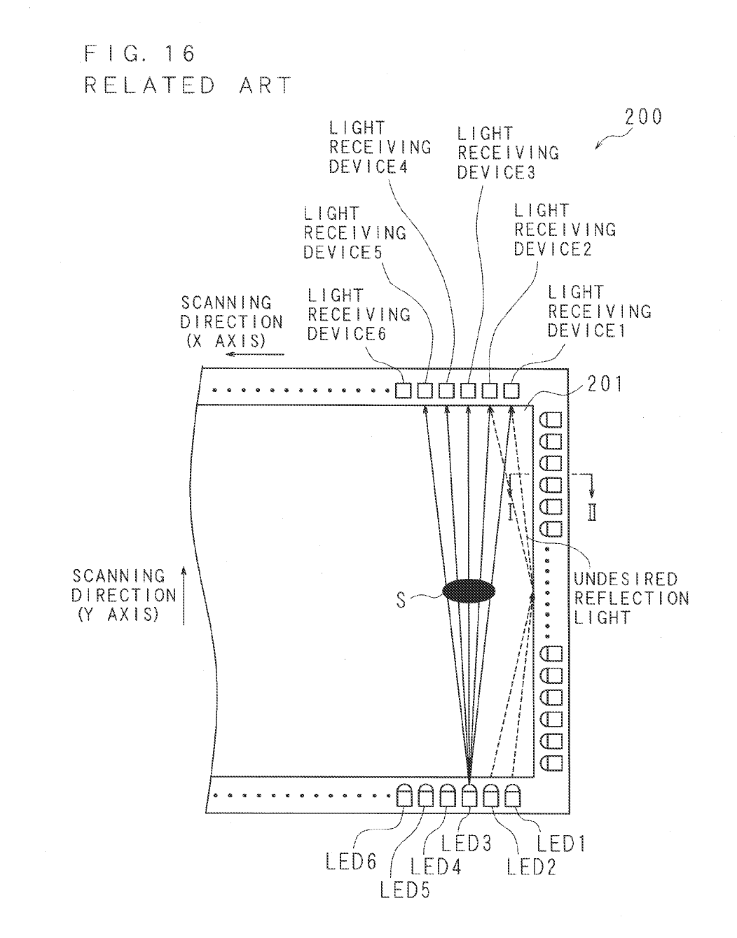

FIG. 17 is a cross sectional view taken from line I-II of FIG. 16.

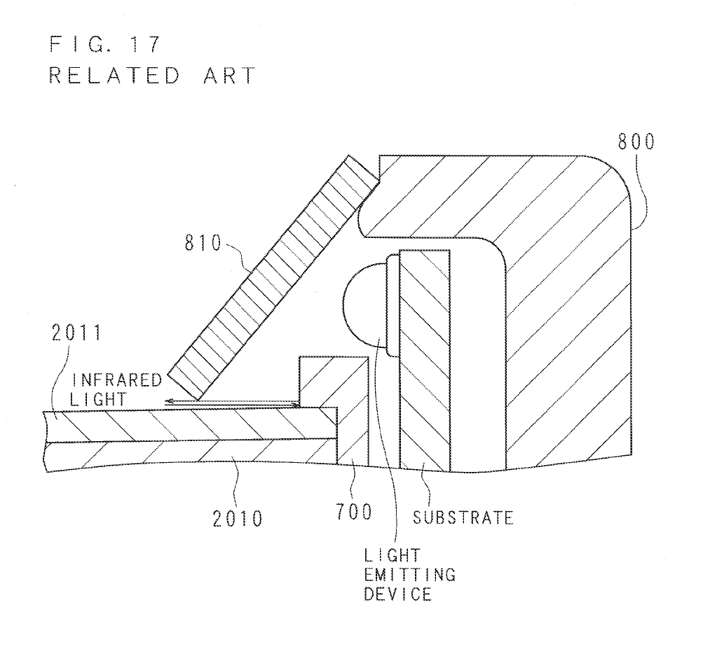

### DETAILED DESCRIPTION OF NON-LIMITING EXAMPLE EMBODIMENTS

Hereinafter, a touch panel device (touch screen device, touch screen system) according to the present invention is described with reference to the drawings by taking a case as an example where the touch panel device according to the present invention is applied to a so-called electronic whiteboard.

### Embodiment 1

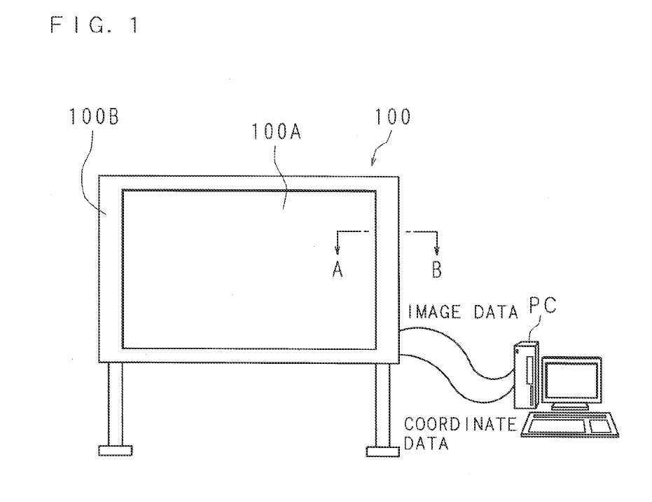

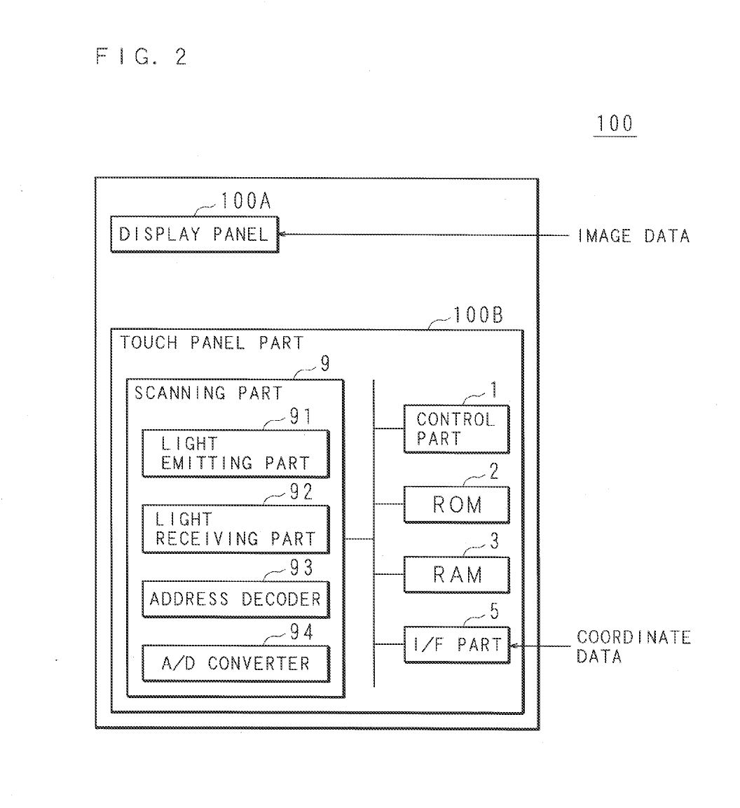

FIG. 1 is a conceptual diagram conceptually illustrating an electronic whiteboard 100 according to Embodiment 1 of the present invention, and FIG. 2 is a functional block diagram illustrating a main configuration of the electronic whiteboard 100 according to Embodiment 1 of the present invention.

The electronic whiteboard 100 according to Embodiment 1 of the present invention includes a display part (display panel) 100A and a touch panel part 100B. The touch panel part 100B is configured as a so-called touch panel of an infrared ray blocking type, which includes a light emitting device emitting infrared ray and a light receiving device receiving the infrared ray and detects a position of a light blocking object. In the electronic whiteboard 100, for example, the display panel 100A and the touch panel part B are connected to a personal computer (hereinafter, referred to as a PC) through an HDMI (registered trademark) and an USB, respectively. In the present embodiment, the display panel 100A and the touch panel part 100B are separately configured according to different functions of image display and coordinate instruction. However, the display panel 100A and the touch panel part 100B may be configured/controlled integrally for the purpose of, for example, synchronizing image display and coordinate instruction. Also, an I/F for image display and coordinate instruction is not restricted to an HDMI or a USB, but can be a different manner.

The display panel 100A is configured with, for example, an LCD or an EL (Electroluminescence) panel on which an image outputted from a PC and a text, a line drawing or the like received from a user through the touch panel part 100B and the PC are displayed. Also, the touch panel part 100B is placed so as to enclose a display screen of the display panel 100A.

The touch panel part 100B includes a control part (section) 1, a ROM 2, a RAM 3, an I/F part 5, and a scanning part 9. Coordinate data is transmitted/received to/from the PC via the I/F part 5.

The control part 1 of the touch panel part 100B receives a writing/line art such as a text or a line drawing through the PC based on coordinates according to a result of scan by the scanning part 9, thereby causing the display panel 100A to display the text, the line drawing or the like.

A control program is preliminary stored in the ROM 2, and the RAM 3 can store data temporarily and read out the data irrespective of a storing order, a stored position or the like. Also, the RAM 3 stores, for example, a program read from the ROM 2 and various data generated by executing the program.

By loading a control program preliminary stored in the ROM 2 on the RAM 3 and executing the same, the control part 1 controls the above-mentioned various types of hardware via a bus and causes the touch panel part 100B to function.

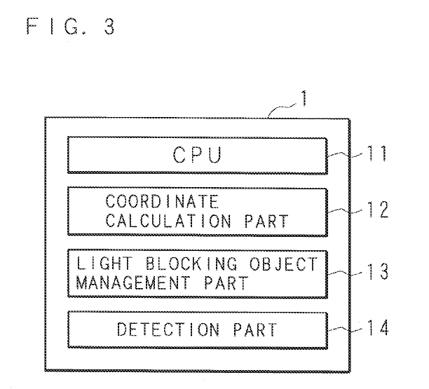

FIG. 3 is a functional block diagram illustrating a main configuration of the control part 1 in the touch panel part 100B of the electronic whiteboard 100 according to Embodiment 1 of the present invention. The control part 1 includes a CPU 11, a coordinate calculation part 12, a light blocking object management part 13, and a detection part 14.

The coordinate calculation part 12 calculates the coordinates of a light blocking object such as a pen-type input device or a finger on a display screen of the display panel 100A. More specifically, the coordinate calculation part 12 calculates the coordinates of the light blocking object based on an strength signal (described later) which is transmitted from the touch panel part 100B when light shielding is detected on the display screen of the display panel 100A.

The light blocking object management part 13 manages the position (coordinates) of a light blocking object detected by scanning by the scanning part 9. For example, when the light blocking object moves, the light blocking object management part 13 stores a coordinate history representing the movement of the light blocking object.

The detection part 14 detects the position of one or more light blocking objects on the display screen of the display panel 100A. More specifically, the scanning part 9 of the touch panel part 100B performs scanning of light for the entire area of the display screen of the display panel 100A and, based on a strength signal according to a result of the scanning of the entire area obtained from the touch panel part 100B, the detection part 14 detects the coordinates of the light blocking object on the display screen of the display panel 100A.

Also, the CPU 11 controls the light emitting device and the light receiving device of the scanning part 9.

The touch panel part 100B is a touch panel of an infrared ray blocking type as described above. That is, light shielding is detected as a pen type input device or a tip of a finger (not illustrated) approaches the proximity of the display screen of the display panel 100A, whereby the position of the light blocking object (a pen type input device or a finger or the like) is detected. That is, a signal (strength signal) obtained from the light receiving device as a result of scanning is transmitted to the control part 1, and based on the signal, the coordinate calculation part 12 calculates the coordinates of the light blocking object. In this manner, the touch panel part 100B receives an input of position specification, text, line drawing or the like on the display panel 100A from a user.

The touch panel part 100B includes the scanning part 9 which scans the display screen of the display panel 100A with infrared light. The scanning part 9 includes a light emitting part 91 having a plurality of light emitting devices that radiate infrared light, a light receiving part 92 having a plurality of light receiving devices that receive infrared light from the corresponding light emitting devices, an address decoder 93 assigning a light emitting signal and a light receiving signal from the control part 1 (CPU 11) to the light emitting part 91 and the light receiving part 92, respectively, and an A/D converter 94 converting an analog signal from the light receiving part 92, which is used for detection of light shielding, into a digital signal.

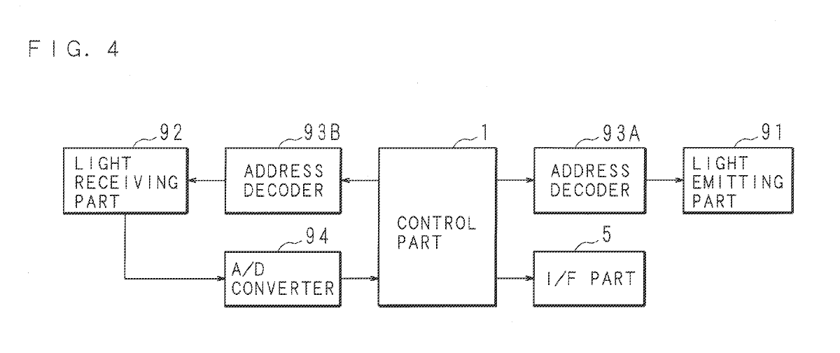

FIG. 4 is a functional block diagram illustrating a process of light scanning in the electronic whiteboard 100 according to Embodiment 1 of the present invention.

The light emitting part 91 includes a multiplexer (not illustrated) to which each of the light emitting devices is connected. Also, the light receiving part 92 includes a multiplexer (not illustrated) to which each of the light receiving devices is connected. Moreover, each of the light emitting devices of the light emitting part 91 is configured to correspond to (oppose to) any one of the light receiving devices of the light receiving part 92.

The CPU 11 of the control part 1 outputs a light emitting signal for causing the plurality of light emitting devices to emit light to the address decoder 93A while outputting a light receiving signal for causing the plurality of light receiving devices to receive light to the address decoder 93B. In response to the signal from the CPU 11, the address decoder 93A outputs a signal to the light emitting part 91, which specifies any one of the light emitting devices that concerns the light emission. In response to the signal from the CPU 11, the address decoder 93B outputs a signal to the light receiving part 92, which specifies any one of the light receiving devices that corresponds to the specified light emitting device.

The light emitting device specified in such a manner emits infrared light, and the corresponding light receiving device receives the infrared light. Here, a strength signal indicating the intensity of the infrared light received by the light receiving device as a voltage value is outputted to the A/D converter 94. The A/D converter 94 coverts the strength signal to, for example, an 8-bit digital signal, and outputs the converted strength signal to the control part 1. The control part 1 sequentially repeats the process of obtaining the strength signal from each of the light receiving devices in order to obtain strength signals from all the light receiving devices.

The CPU 11 of the control part 1 calculates the amount of light received by the light receiving device based on the strength signals obtained from each of the light receiving devices. If the calculated amount of the light received exceeds a predetermined threshold, the CPU 11 determines that an optical path of infrared light to be received by the light receiving device is not shielded. Also, if the calculated amount of the light received does not exceed the predetermined threshold, the CPU 11 determines that the optical path of infrared light to be received by the light receiving device is shielded.

Based on the decision result of the CPU 11, the coordinate calculation part 12 and the detection part 14 calculate the position of the light blocking object. That is, the coordinate calculation part 12 and the detection part 14 specify a light receiving device of which optical path of infrared light is shielded, and, based on the position of the specified light receiving device, perform a process of calculating the coordinates of the light blocking object on the display screen of the display panel 100A.

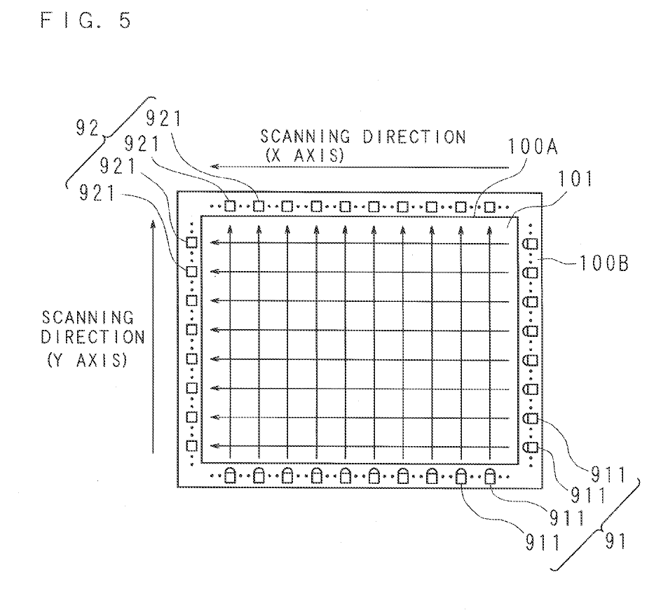

The scanning and detection of a light blocking object are described in detail below. FIG. 5 is an explanatory view illustrating scanning and detection of a light blocking object in the electronic whiteboard 100 according to Embodiment 1 of the present invention.

The display screen of the display panel 100A has a rectangular shape. On the right side and the lower side of the display screen as shown in the drawing, arrays composed of light emitting devices 911, 911, . . . are disposed along the edge of the display panel 100A. The light emitting devices 911 are, for example, light emitting diodes (LEDs) emitting infrared light. In FIG. 5, an optical path of infrared light emitted from each of the light emitting devices 911 is indicated with an arrow of a solid line.

The plurality of light emitting devices 911, 911, . . . on the right side are positioned in such a manner that optical paths of infrared light emitted from each light emitting device 911 are parallel to each other along the display screen. The light emitting devices 911, 911, . . . on the lower side are positioned in a similar manner.

That is, it is configured in such a manner that optical paths in the right-and-left direction (X-axis direction) from the light emitting devices 911, 911, . . . on the right side and optical paths in the up-and-down direction (Y-axis direction) from the light emitting devices 911, 911, . . . on the lower side are orthogonal to each other.

Also, the light receiving devices 921, 921, . . . are placed in positions which are on the display screen of the display panel 100A and opposite to the light emitting devices 911, 911, . . . .

That is, on the left side and the upper side of the display screen of the display panel 100A, arrays composed of the plurality of light receiving devices 921, 921, . . . are placed along the edges of the display panel 100A. The light receiving devices 921 are light receiving diodes receiving infrared light. It is configured that the infrared light from the light emitting devices 911, 911, . . . is received by the opposing light receiving devices 921, 921, . . . .

As in the light emitting devices, the light receiving devices 921, 921, . . . on the upper side and the light receiving devices 921, 921, . . . on the left side are arranged so that the optical paths of infrared light to be received are orthogonal to each other.

The scanning part 9 causes the light emitting devices 911 to sequentially emit light one by one, from one end to the other end in the X axis direction and also from one end to the other end in the Y axis direction on the display screen of the display panel 100A, thereby detecting the position, size or the like of a light blocking object on the display screen of the display panel 100A.

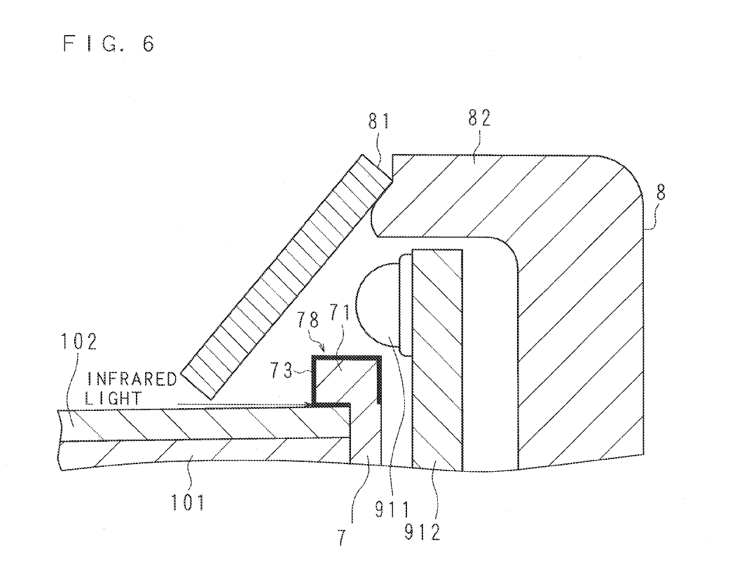

FIG. 6 is a cross sectional view taken from line A-B of FIG. 1.

The electronic whiteboard 100 includes a display screen 101 of the display panel 100A, a cover glass 102 placed at a front side of the display screen 101, and a bezel part 8 positioned along a border of the display screen 101. The present embodiment shows a configuration in which the cover glass 102 is combined with the display screen 101 of the display panel 100A. It is also possible to have a configuration that a transparent resin molding is applied for protecting the display screen 101 of the display panel 100A.

The bezel part 8 has a hollow frame body 82 covering the border of the display screen 101, and the light emitting devices 911, 911, . . . (or the light receiving devices 921, 921, . . . ) are housed inside the frame body 82. A transparent board 81 is provided at an end portion of the display screen 101 side of the bezel part 8.

The transparent board 81 is, as described above, a plate with a rectangular shape disposed so as to cover the light emitting devices 911, 911, . . . and the light receiving devices 921, 921, . . . positioned side by side in the X direction and the Y direction. The transparent board 81 allows infrared light emitted from the light emitting devices 911, 911, . . . and the infrared light entered into the light receiving devices 921, 921, to pass through. Moreover, the transparent board 81 has functions of preventing the light emitting devices 911, 911, . . . and the light receiving devices 921, 921, . . . inside the frame body 82 from being seen from outside, protecting a substrate on which the light emitting devices and the light receiving devices are mounted, and serving as a band pass filter through which only a peak wavelength (for example, near infrared wavelength at the vicinity of 850 nm) of light emitted from the light emitting devices passes. The reason why the transparent board 81 is not vertical but inclined with respect to the display screen 101 and the cover glass 102 is to avoid influence of undesired reflection light on a surface of the transparent board 81. When the transparent board 81 is substantially vertical with respect to the display screen 101 and the cover glass 102, light emitted from the light emitting devices 911 may be reflected at the transparent board 81 and detected by the light receiving devices 921. On the other hand, light emitted from the light emitting devices 911 and directed to the inclined transparent board 81 is reflected in a direction away from the display screen 101 and the cover glass 102 (upward the cover glass 102). Thus, it is not likely that the light receiving devices 921 are affected by undesired reflection light reflected by the transparent board 81.

Also, the transparent board 81 is made of, for example, polycarbonate, acryl or the like, and has a width in the shorter direction of 16 mm, for example. In a state where the both long side portions on the rear side are supported by an end portion of the frame body 82 and the display screen 101, the transparent board 81 is adhered to the end portion of the frame body 82 by an adhesive or the like.

Inside the frame body 82, the light emitting devices 911, 911, . . . are mounted on the substrate 912 placed in a direction orthogonal to the display screen 101. Infrared light emitted from the light emitting devices 911, 911, . . . emits through the transparent board 81, enters through the transparent board 81 of the opposing light receiving part 92 and is received by the light receiving devices 921, 921, . . . .

On the other hand, the display panel 100A (display screen 101) and the cover glass 102 are held at their positions by the holding member 7. The holding member 7 is placed in the vicinity of a border of the display panel 100A and holds the display screen 101 and the cover glass 102 so as to cover border sides of the display screen 101 and the cover glass 102.

More specifically, the cover glass 102 has a rectangular shape which is substantially in the same size as the display screen 101, and is mounted so as to be in contact with the front side of the display screen 101. The holding member 7 is placed so as to be in contact with the border of such a cover glass 102 with a predetermined width and clips the cover glass 102 and the display panel 100A (display screen 101).

On the holding member 7, an antireflection part 78 which suppresses that the light emitted from the light emitting devices 911 is reflected and received by the light receiving devices 921 is placed. More specifically, on the holding member 7, the antireflection part 78 is placed, which prevents infrared light directed to a fixing part 71 which holds the display screen 101 and the cover glass 102 from being reflected in a direction along the display screen 101. That is, the fixing part 71 which is a part of the holding member 7 covers the border portion of the display screen 101 and the cover glass 102. A light absorption film 73 which absorbs infrared light is placed outside the fixing part 71. The light absorption film 73 is placed so as to cover the fixing part 71 and absorbs infrared light directed toward the fixing part 71.

The light absorption film 73 contains a compound of, for example, azo, aminium, anthraquinone, cyanine, diimmonium, dithiol metal complex, squarylium, naphthalocyanine, phthalocyanine or the like.

Also, it is not restricted to compounds as mentioned above. The light absorption film 73 may be configured by a process of surface blasting such as polishing, application of a matte coating agent, or adhering of an AR (Anti-Reflection) film, moth eye film or the like.

Moreover, the light absorption film 73 may be configured to include chlorophyl of a photosynthetic pigment, for example. More specifically, the light absorption film 73 is configured in a manner that, for example, green tea powder or the like containing chlorophyl component is blended with an appropriate solvent (for example, an acrylic solvent, an enamel solvent) and coated thereon.

Chlorophyl is a chemical substance having a role for absorbing light energy by a photosynthesis reaction and can absorb infrared light as absorbing light in the wavelength around 450 nm, 700 nm, and 850 mn. As an example of chlorophyl component, chlorophyl d and bacteriochlorophyl a are mentioned.

More specifically, the light absorption film 73 is configured by mixing 5% of green tea powder with an acrylic solvent and coating it thereon.

The electronic whiteboard 100 according to Embodiment 1 of the present invention can solve the problem of a false detection of the position of a light blocking object (light shielding failure) as described above with the antireflection part 78 (light absorption film 73). Detailed description is provided below.

For example, in a case where the electronic whiteboard is large-sized and the display screen 101 is vertical with respect to a floor, a gap may be generated between the transparent board 81 and the cover glass 102 (display screen 101) because the display screen 101 and the cover glass 102 are deformed by their own weights or due to a margin of error in a mechanism design or manufacturing.

In such a case, a part of infrared light emitted from the light emitting devices 911 at the right and left ends of the lower side of the light emitting part 91 or the upper and lower ends of the right side of the light emitting part 91 in FIG. 5 passes through the gaps at the right and left sides of the bezel part 8 or the gaps at the upper and lower sides of the bezel part 8, and the part of the infrared light hits on the fixing part 71 of the holding member 7 and is reflected, and received as undesired reflection light by the light receiving devices 921 at the right and left ends of the upper side of the light receiving part 92 or the upper and lower ends of the left side of the light receiving part 92. Due to the phenomenon, the undesired reflection light blocks a change in the amount of light to be shielded by a light blocking object, which results in the false detection of a position (light shielding failure).

However, as described above, in the electronic whiteboard 100 according to Embodiment 1 of the present invention, the light absorption film 73 is provided on the fixing part 71 of the holding member 7. Thus, even if the infrared light passing through the gap and entering inside the transparent board 81 hits on the fixing part 71, the reflection of the light is suppressed and the light is absorbed by the light absorption film 73. Accordingly, generation of the undesired reflection light is suppressed and the false detection of the position of the light blocking object due to the undesired reflection light can be avoided.

In the above description, it is described by taking a case as an example where the light absorption film 73 is provided on the fixing part 71 of the holding member 7 as the antireflection part 78. However, the present invention is not restricted to the case.

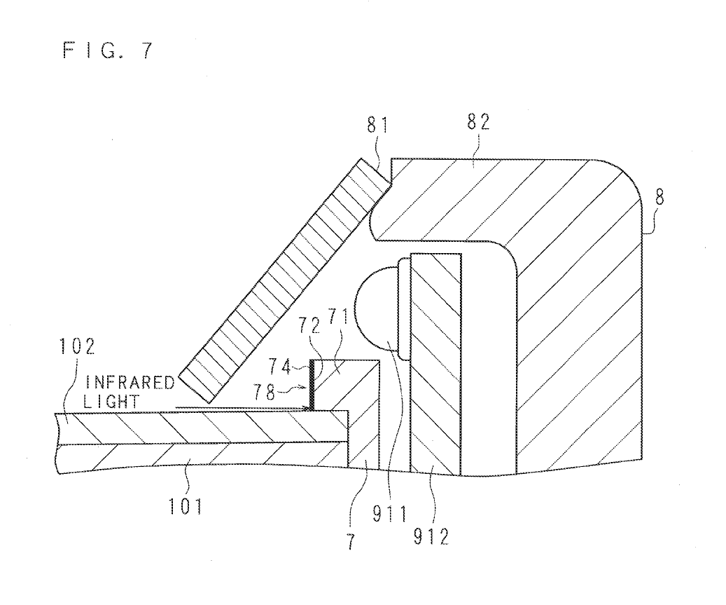

FIG. 7 is an explanatory view illustrating Modification 1 of a configuration of the antireflection part 78 in the electronic whiteboard 100 according to Embodiment 1 of the present invention.

In Modification 1 of the antireflection part 78 according the Embodiment 1 of the present invention, the holding member 7 also includes the antireflection part 78 provided at the fixing part 71 at the cover glass 102 (or the display screen 101) side. However, the configuration thereof is different.

More specifically, in Modification 1 of the configuration of the antireflection part 78, an end surface 72 of the fixing part 71 is substantially vertical to the cover glass 102 (or the display screen 101) as illustrated in FIG. 7, and a light absorption film 74 absorbing infrared light is provided on the end surface 72. The light absorption film 74 absorbs infrared light directed toward the fixing part 71. Also, the light absorption film 74 is made of the same material as the light absorption film 73 as described above. Accordingly, detailed description thereof is not given.

In Modification 1 regarding the configuration of the antireflection part 78, it is possible to solve the problem of the false detection (light shielding failure) of the position of a light blocking object as described above owing to the antireflection part 78 (light absorption film 74).

As described above, in a case where a part of infrared light emitted from the light emitting devices 911 at the right and left ends of the lower side of the light emitting part 91 or the upper and lower ends of the right side of the light emitting part 91 passes through the gaps at the right and left sides of the bezel part 8 or the gaps at the upper and lower sides of the bezel part 8, and enters, the part of the infrared light hits on the end surface 72 of the fixing part 71 of the holding member 7 and is reflected, and received as undesired reflection light by the light receiving devices 921 at the right and left ends of the upper side of the light receiving part 92 or the upper and lower ends of the left side of the light receiving part 92. Due to the phenomenon, the undesired reflection light blocks a change in the amount of light to be shielded by a light blocking object, which results in the false detection of a position (light shielding failure).

However, as described above, in Modification 1 regarding the configuration of the antireflection part 78, the light absorption film 74 is provided on the end surface 72 of the fixing part 71 of the holding member 7. Thus, even if the infrared light passing through the gap and entering inside the transparent board 81 hits on the fixing part 71 (end surface 72), the light is absorbed by the light absorption film 74 and reflection thereof is suppressed. Accordingly, generation of the undesired reflection light is suppressed and the false detection of the position of the light blocking object due to the undesired reflection light can be avoided.

Also, the configuration of the antireflection part 78 in the electronic whiteboard 100 according to Embodiment 1 is not restricted to the description above.

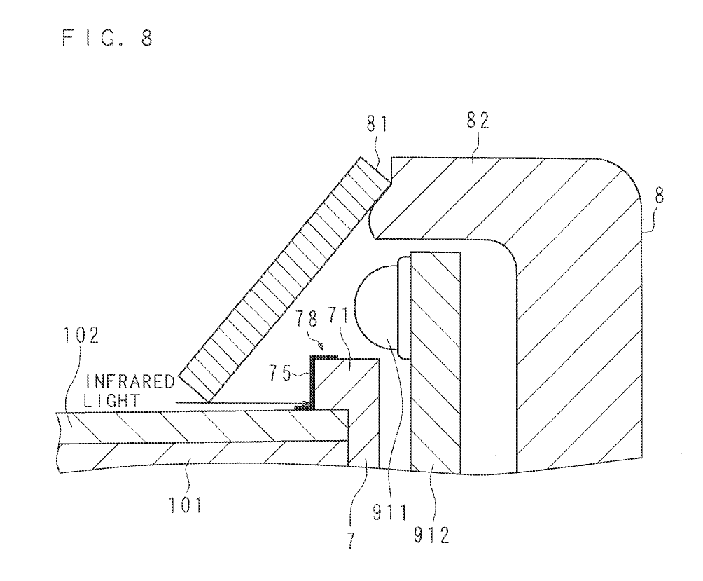

FIG. 8 is an explanatory view illustrating Modification 2 of the configuration of the antireflection part 78 in the electronic whiteboard 100 according to Embodiment 1 of the present invention.

Also, in Modification 2 regarding the configuration of the antireflection part 78 according the Embodiment 1 of the present invention, the holding member 7 includes the antireflection part 78 provided at the fixing part 71 at the cover glass 102 (or the display screen 101) side. However, the configuration thereof is different.

More specifically, in Modification 2 of the configuration of the antireflection part 78, a light absorption sheet 75 that absorbs light is provided not only at an end surface of the fixing part 71 of the holding member 7 but also at the cover glass 102 (or the display screen 101) in the vicinity of the end surface and the upper surfaces of the fixing part 71 (refer to FIG. 8). The light absorption sheet 75 absorbs infrared light directed toward to the fixing part 71. The light absorption sheet 75 is made of the same material as the light absorption film 73 and the light absorption film 74 as described above. Accordingly, detailed description thereof is not given.

In Modification 2 regarding the configuration of such an antireflection part 78, it is possible to solve the problem of the false detection of the position of a light blocking object as described above owing to the antireflection part 78 (light absorption sheet 75).

That is, as described above, in Modification 2 regarding the configuration of the antireflection part 78, the light absorption sheet 75 is provided on the fixing part 71 of the holding member 7. Thus, even if the infrared light passing through the gap and entering inside the transparent board 81 hits on the fixing part 71, the infrared light is absorbed by the light absorption sheet 75 and reflection thereof is suppressed. Accordingly, generation of the undesired reflection light is suppressed and the false detection of the position of the light blocking object due to the undesired reflection light can be avoided.

Also, the configuration of the antireflection part 78 in the electronic whiteboard 100 according to Embodiment 1 is not restricted to the description above.

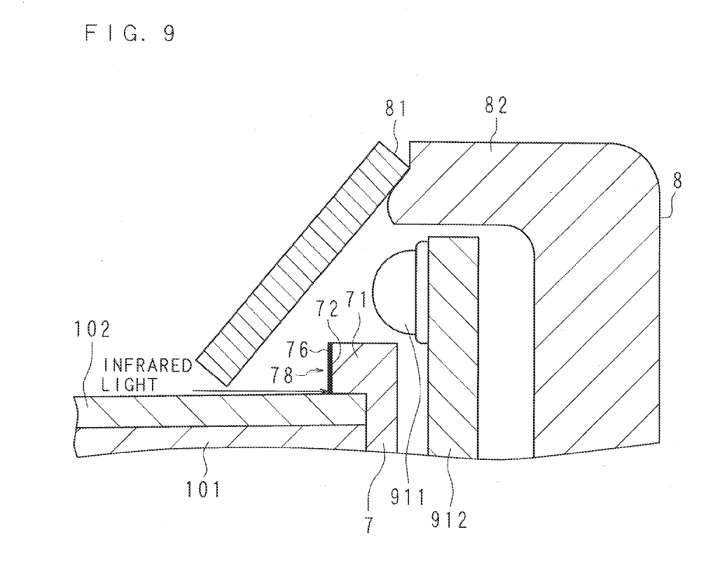

FIG. 9 is an explanatory view illustrating Modification 3 of the configuration of the antireflection part 78 in the electronic whiteboard 100 according to Embodiment 1 of the present invention.

Also in Modification 3 regarding the configuration of the antireflection part 78 according the Embodiment 1 of the present invention, the holding member 7 includes the antireflection part 78 provided at the fixing part 71 at the cover glass 102 (or the display screen 101) side, which prevents infrared light directed to the fixing part 71 from being reflected in a direction along the display screen 101. However, the configuration thereof is different.

In Modification 3 of the configuration of the antireflection part 78, the end surface 72 of the fixing part 71 is substantially vertical to the cover glass 102 (or the display screen 101) as illustrated in FIG. 9, and a light absorption sheet 76 absorbing infrared light is provided on the end surface 72. More specifically, in the above-described light absorption film 74, the end surface 72 is, for example, coated with the light absorption film 74. In Modification 3 of the configuration of the antireflection part 78, the light absorption sheet 76 is adhered to the end surface 72. The light absorption sheet 76 absorbs infrared light directed toward the fixing part 71.

Accordingly, in Modification 3 of the configuration of the antireflection part 78, for example, it is possible to adhere the light absorption sheet 76 after the bezel part 8 has been assembled, which increases a degree of freedom in assembling work. Since the light absorption sheet 76 is made of the same material as the light absorption sheet 75 as described above, a detailed description thereof is not given.

In Modification 3 regarding the configuration of such an antireflection part 78, it is possible to solve the problem of the false detection of the position of a light blocking object as described above owing to the antireflection part 78 (light absorption sheet 76).

That is, as described above, in Modification 3 regarding the configuration of the antireflection part 78, the light absorption sheet 76 is adhered to the end surface 72 of the fixing part 71 of the holding member 7. Thus, even if the infrared light passing through the gap and entering inside the transparent board 81 hits on the fixing part 71, the infrared light is absorbed by the light absorption sheet 76 and reflection thereof is suppressed. Accordingly, generation of the undesired reflection light is suppressed and the false detection of the position of the light blocking object due to the undesired reflection light can be avoided.

### Embodiment 2

According to the electronic whiteboard 100 in Embodiment 1 of the present invention, the antireflection part 78 is described by taking a case as an example where the light absorption film 73 is provided on the fixing part 71 of the holding member 7. However, the present invention is not restricted to the case.

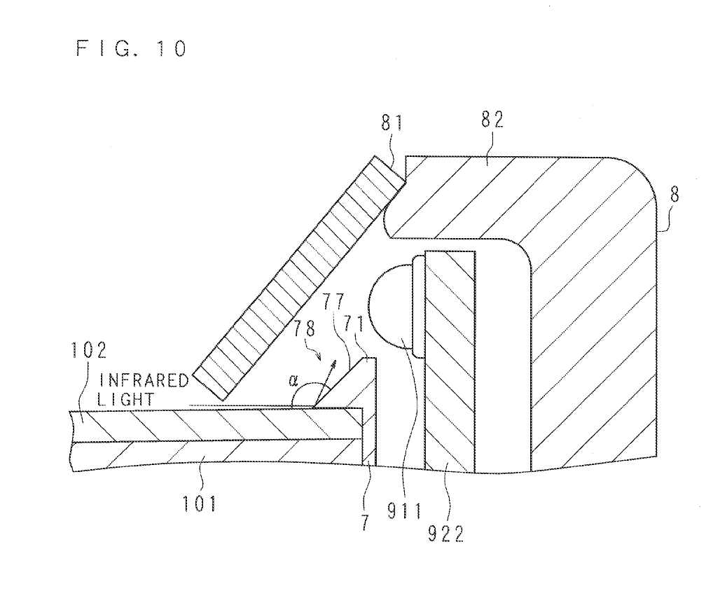

FIG. 10 is an explanatory view illustrating a configuration of the antireflection part 78 in an electronic whiteboard 100 according to Embodiment 2 of the present invention.

In the electronic whiteboard 100 according to Embodiment 2 of the present invention, as in Embodiment 1, the holding member 7 includes the antireflection part 78 provided at the fixing part 71 at a cover glass 102 (or a display screen 101) side, which prevents infrared light directed toward the fixing part 71 from being reflected in a direction along the display screen 101. However, the configuration thereof is different.

More specifically, in the electronic whiteboard 100 according to Embodiment 2 of the present invention, at an end of the fixing part 71, a slant plane 77 having an obtuse angle α with respect the cover glass 102 (or the display screen 101) is formed, as illustrated in FIG. 10.

That is, the fixing part 71 is formed in such a manner that the width of a portion covering the border of the cover glass 102 becomes narrower towards the end of the fixing part 71. The fixing part 71 of the present embodiment has a flat surface being in contact with a border of the cover glass 102. The slant plane 77 adjacent to the flat surface is cut so as to form an obtuse angle α with respect the cover glass 102 (or the display screen 101). The slant plane 77 reflects the infrared light directed toward the fixing part 71 in a direction away from the cover glass 102 (or display screen 101) (refer to FIG. 10).

The electronic whiteboard 100 according to Embodiment 2 of the present invention can solve the problem of the false detection of the position of a light blocking object as described above owing to the antireflection part 78 (slant plane 77).

As described above, in a case where a part of infrared light emitted from the light emitting devices 911 at the right and left ends of the lower side of the light emitting part 91 or the upper and lower ends of the right side of the light emitting part 91 in FIG. 5 passes through the gaps at the right and left sides of the bezel part 8 or the gaps at the upper and lower sides of the bezel part 8, and enters, the part of the infrared light hits on the fixing part 71 of the holding member 7 and is reflected, and received as undesired reflection light by the light receiving devices 921 at the right and left ends of the upper side of the light receiving part 92 or the upper and lower ends of the left side of the light receiving part 92. Due to the phenomenon, the undesired reflection light blocks a change in the amount of light to be shielded by a light blocking object, which results in the false detection of a position (light shielding failure).

However, as described above, in the electronic whiteboard 100 according to Embodiment 2 of the present invention, the slant plane 77 is formed on the fixing part 71 of the holding member 7. Thus, even if the infrared light passing through the gap and entering inside the transparent board 81 hits on the fixing part 71, the infrared light is reflected by the slant plane 77 in a direction away from the cover glass 102 (or the display screen 101). Accordingly, the undesired reflection light is not generated and the false detection of the position of the light blocking object due to the undesired reflection light can be avoided.

In the description above, a case is described as an example that, at the end of the fixing part 71, the slant plane 77 having an obtuse angle α with respect the cover glass 102 (or the display screen 101) is formed. However, the present invention is not restricted to the case.

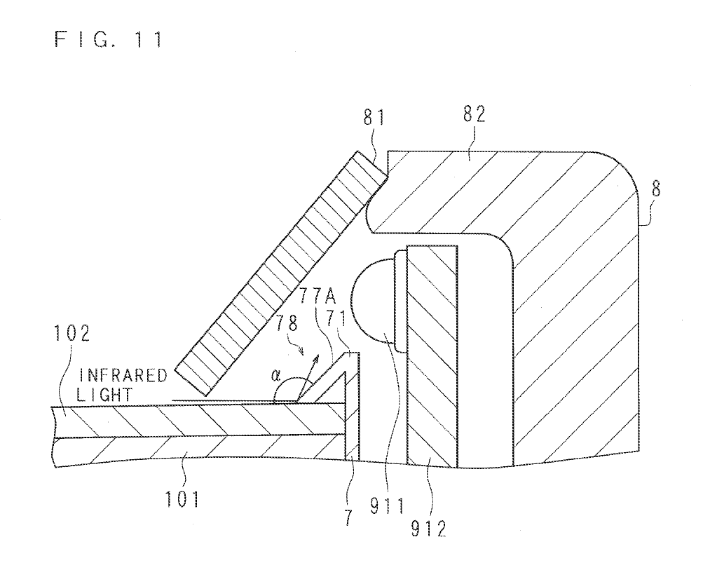

FIG. 11 is an explanatory view illustrating a modification of the configuration of the antireflection part 78 in the electronic whiteboard 100 according to Embodiment 2 of the present invention.

Also in the modification of the configuration of the antireflection part 78 according to Embodiment 2 of the present invention, the holding member 7 includes the antireflection part 78 provided at the fixing part 71 at a cover glass 102 (or a display screen 101) side, which prevents infrared light directed toward the fixing part 71 from being reflected in a direction along the display screen 101. However, the configuration thereof is different.

More specifically, in the modification of the configuration of the antireflection part 78 according to Embodiment 2 of the present invention, at an end of the fixing part 71, a slant plane 77A having an obtuse angle α with respect the cover glass 102 (or the display screen 101) is formed, as illustrated in FIG. 11.

That is, the fixing part 71 is subjected to a bending process to be bent toward the cover glass 102 side and formed in such a manner that the bent portion covers a border of the cover glass 102. Also, the slant plane 77A which is outside the bent portion is bent so as to form an obtuse angle α with respect the cover glass 102 (or the display screen 101). The slant plane 77A reflects infrared light directed toward the fixing part 71 in a direction away from the cover glass 102 (or the display screen 101) (refer to FIG. 11).

In the modification regarding the configuration of the antireflection part 78 according to Embodiment 2 of the present invention, it is possible to solve the problem of the false detection of the position of a light blocking object as described above owing to the antireflection part 78 (slant plane 77A).

That is, in the modification regarding the configuration of the reflection prevention 78 according to Embodiment 2 of the present invention, as described above, the slant plane 77A is provided at the fixing part 71 of the holding member 7. Thus, even if the infrared light passing through the gap and entering inside the transparent board 81 hits on the fixing part 71, the infrared light is reflected by the slant plane 77A in a direction away from the cover glass 102 (or the display screen 101). Accordingly, undesired reflection light is not generated and the false detection of the position of the light blocking object due to the undesired reflection light can be avoided.

Same reference numerals are assigned to the portions which are similar to those in Embodiment 1, and no detailed description thereof is provided.

### Embodiment 3

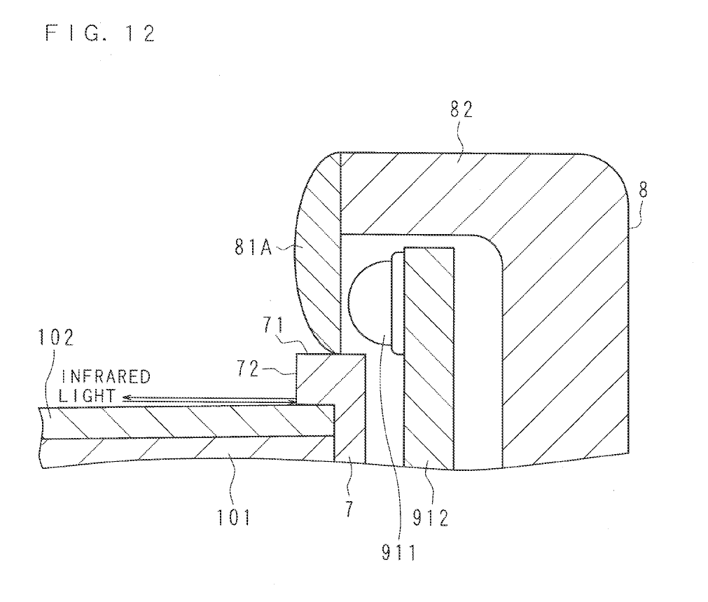

FIG. 12 is an explanatory view illustrating a configuration of the antireflection part 78 in an electronic whiteboard 100 according to Embodiment 3 of the present invention.

In the electronic whiteboard 100 illustrated in FIG. 12, a transparent board 81A is placed substantially vertical with respect to a cover glass 102 (or a display screen 101). Infrared light emitted from light emitting devices 911, 911, . . . emits toward opposing light receiving devices 921, 921, . . . through the transparent board 81A, and enters the light receiving devices 921, 921, . . . through the transparent board 81A.

In Embodiment 3, a front side surface on the cover glass 102 side of the transparent board 81A forms an arc-shaped projecting portion for the purpose of dispersing reflection directions on the front side surface of the transparent board 81A such that the undesired reflection light does not reach the light receiving devices 921 directly. The transparent board 81A is provided at the upper side the fixing part 71 of the holding member 7 and the fixing part 71 of the holding member 7 is provided at an end portion on the cover glass 102 side of the transparent board 81A.

Thus, also in the electronic whiteboard 100 according to Embodiment 3, the above-described problem of the false detection of the position of a light blocking object occurs. That is, when a part of the infrared light emitted from the light emitting devices 911, 911, . . . traveling in contiguity with the front side of the cover glass 102 hits on the fixing part 71 of the holding member 7 and is reflected, the part of the light travels along the cover glass 102 again and is received by any one of the light receiving devices 921. In such a case, the amount of light received at the light receiving devices 921 is increased, which may lead to the false detection of the position of a light blocking object.

To address this, as described in Embodiments 1 and 2, by providing the light absorption film 73 or the light absorption sheet 75 at the fixing part 71 of the holding member 7, or providing the light absorption film 74 or the light absorption sheet 76 at the end surface 72 of the fixing part 71 of the holding member 7, or forming the slant plane 77 or the slant plane 77A on the fixing part 71 of the holding member 7, the above-mentioned problem of the false detection of the position of a light blocking object can be solved.

Same reference numerals are assigned to the portions which are similar to those in Embodiment 1, and no detailed description thereof is provided.

### Embodiment 4

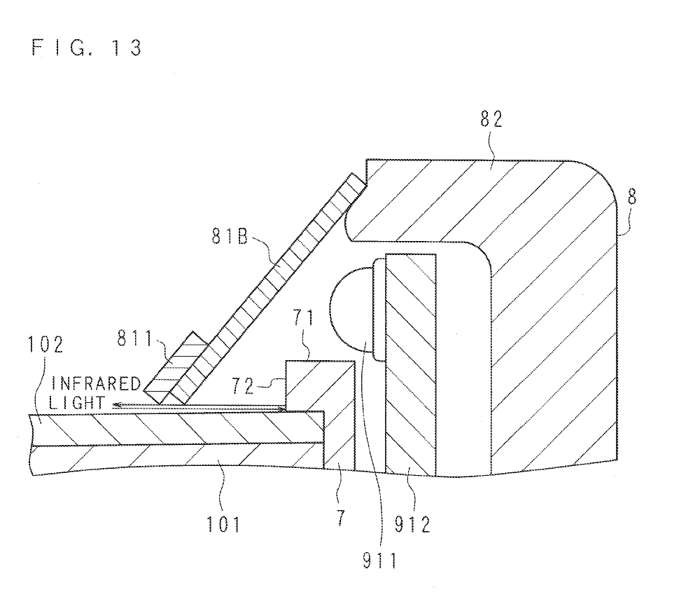

FIG. 13 is an explanatory view illustrating a configuration of the antireflection part 78 in an electronic whiteboard 100 according to Embodiment 4 of the present invention.

In the electronic whiteboard 100 illustrated in FIG. 13, a substrate 912 (or a substrate 922) on which light emitting devices 911 (or light receiving devices 921) are mounted is disposed in a position which is inside of a bezel part 8 and also between the holding member 7 and the bezel part 8. The light emitting devices 911 (or the light receiving devices 921) are covered with a transparent board 81B extending from a border of a cover glass 102 to an end portion of the bezel part 8 and being slant to the cover glass 102.

In the electronic whiteboard 100 according to Embodiment 4, a reflection prevention tape 811 is adhered to the border on the cover glass 102 side of the transparent board 81B for preventing reflection of infrared light. By placing the transparent board 81B so as to be slant with respect to the cover glass 102, it is possible to avoid reflection of infrared light on the surface of the transparent board 81B directly affecting the light receiving devices 921. In fact, the influence of the reflection of infrared light still remains at an edge portion (where the reflection prevention tape 811 is adhered) where the transparent board 81B is in contact with the cover glass 102 (for example, assuming that influence by the undesired reflection light when the transparent board 81B is installed in a vertical manner is 100%, a few % remains.) The influence may be avoided with the reflection prevention tape 811.

However, in the electronic whiteboard 100 according to Embodiment 4 of the present invention, the problem of the false detection of the position of a light blocking object as described above also occurs. That is, there may be a case that a gap is generated between the transparent board 81B and the cover glass 102 (or the display screen 101), and a part of infrared light emitted from the light emitting devices 911, 911 . . . enters inside of the transparent board 81B thought the gap, as illustrated in FIG. 13. In such a case, the infrared light entered inside of the transparent board 81B hits on the fixing part 71 of the holding member 7 and is reflected, thereby traveling through the gap again and being received by any one of the light receiving devices 921. In such a case, the amount of light received by the light receiving devices 921 is increased, which leads to the false detection of the position of a light blocking object.

To address this, as described in Embodiments 1 and 2, by providing the light absorption film 73 or the light absorption sheet 75 on the fixing part 71 of the holding member 7, or providing the light absorption film 74 or the light absorption sheet 76 at the end surface 72 of the fixing part 71 of the holding member 7, or forming the slant plane 77 or the slant plane 77A on the fixing part 71 of the holding member 7, the above-mentioned problem of the false detection of the position of a light blocking object can be solved.

Same reference numerals are assigned to the portions which are similar to those in Embodiment 1, and no detailed description thereof is provided.

### Embodiment 5

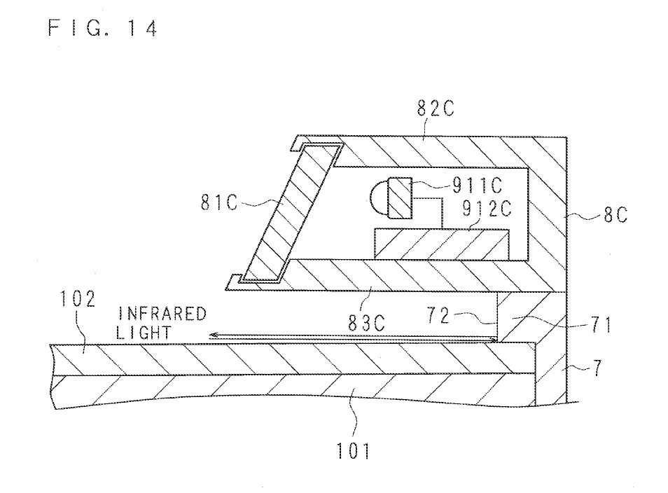

FIG. 14 is an explanatory view illustrating a configuration of an antireflection part 78 in an electronic whiteboard 100 according to Embodiment 5 of the present invention.

In the electronic whiteboard 100 illustrated in FIG. 14, a bezel part 8C is placed on the fixing part 71 of the holding member 7. Both side walls 82C, 83C of the bezel part 8C are formed so as to be substantially parallel to a cover glass 102 (or a display screen 101). Inside of the bezel part 8C, a substrate 912C is positioned in a longitudinal direction and light emitting devices 911C, 911C, . . . (or light receiving devices 921, 921, . . . ) are mounted on the substrate 912C, and a transparent board 81C is held by a groove formed at an opening side of the bezel part 8C. In other words, the light emitting devices 911C, 911C, . . . (or the light receiving devices 921C, 921C, . . . not illustrated) placed at inside of the bezel part 8C are hidden by the transparent board 81C.

However, in the embodiment of the electronic whiteboard 100, the problem of the false detection of the position of a light blocking object as described above also occurs. That is, also in the embodiment of the electronic whiteboard 100, an end surface of the fixing part 71 of the holding member 7 is exposed. Accordingly, when a part of the infrared light emitted from the light emitting devices 911C, 911C, . . . travelling in contiguity with the front side of the cover glass 102 hits on the fixing part 71 of the holding member 7 and is reflected, the part of the light travels along the cover glass 102 again and is received by any one of the light receiving devices 921C. In such a case, the amount of light received at the light receiving devices 921C is increased, which may lead to the false detection of the position of a light blocking object.

As described in Embodiments 1 and 2, the above-mentioned problem of the false detection of the position of a light blocking object can be solved by providing the light absorption film 73 or the light absorption sheet 75 at the fixing part 71 of the holding member 7, or providing the light absorption film 74 or the light absorption sheet 76 at the end surface 72 of the fixing part 71 of the holding member 7, or forming the slant plane 77 or the slant plane 77A on the fixing part 71 of the holding member 7.

### Embodiment 6

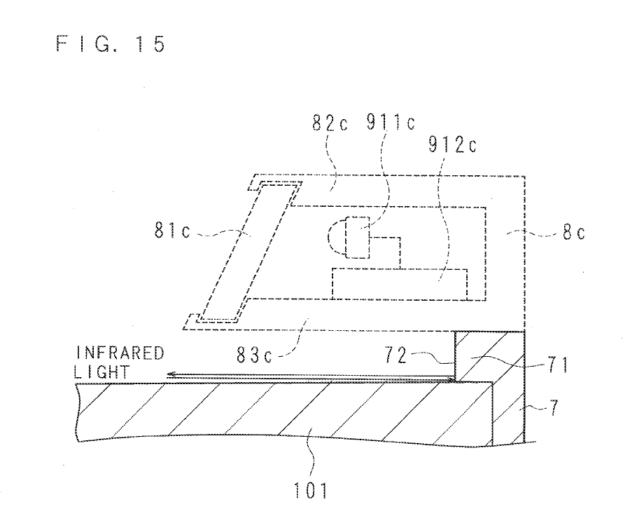

FIG. 15 is an explanatory view illustrating a configuration of an antireflection part 78 in an electronic whiteboard 100 according to Embodiment 6 of the present invention.

The solid lines in FIG. 15 illustrate a part which excludes a cover glass 102 as well as a bezel part 8 (indicated by dotted lines) including, light emitting devices 911C, 911C, . . . light receiving devices 921C, 921C . . . (not illustrated), a substrate 912C, and a substrate 922C (not illustrated) or the like. That is, the electronic whiteboard 100 according to Embodiment 6 of the present invention is configured by incorporating, in the portion indicated with the solid lines in FIG. 15, the bezel part 8 including the light emitting devices 911C, 911C . . . , the light receiving devices 921C, 921C . . . , the substrate 912C, the substrate 922C or the like (refer to FIG. 14). In the present embodiment, a transparent resin (not illustrated) is provided in place of a cover glass 102 in order to protect a surface of a display panel.

In this case also, the end surface 72 of the fixing part 71 is still exposed. Thus, needless to say, the problem of the false detection of a light blocking object as described above occurs in the electronic whiteboard 100 according to Embodiment 6.

To address this, as described in Embodiments 1 and 2, by providing the light absorption film 73 or the light absorption sheet 75 at the fixing part 71 of the holding member 7, or providing the light absorption film 74 or a light absorption sheet 76 at the end surface 72 of the fixing part 71 of the holding member 7, or forming the slant plane 77 or the slant plane 77A on the fixing part 71 of the holding member 7, the above-mentioned problem of the false detection of the position of a light blocking object can be solved.

Same reference numerals are assigned to the portions which are similar to those in Embodiment 1, and no detailed description thereof is provided.

### Embodiment 7

In the above description, although the present invention is described by taking a so-called infrared ray blocking type-touch panel as an example, the present invention is not restricted to the case. The present invention can be applied to, for example, a touch panel using a retroreflective material (for convenience of explanation, referred to as a retroreflective type touch screen, hereinafter).

In the retroreflective type touch panel, for example, a retroreflective material is placed at each of four corners of a display screen, and an optical unit is placed at both end portions of a long side or a short side of the display screen. The optical unit is provided with a laser diode emitting infrared laser light, a collimator lens turning the laser light to a parallel light, a photo diode receiving a reflection light from the retroreflective material, an aperture mirror reflecting the reflection light from the retroreflective material through a polygon mirror to the photodiode, or the like. The laser light emitted from the laser diode is turned to a parallel light by the collimator lens, and is scanned with different angles within a plane substantially parallel to the display screen and directed to the retroreflective material by the polygon mirror. The light reflected by the retroreflective material is reflected by the polygon mirror, and the aperture mirror, and received by the photo diode. If a finger or a pen is present on an optical path which is scanned in the manner, the amount of light detected by the photo diode is decreased. The presence angle of the finger or the pen is calculated based on the timing when the light beam is blocked by the finger or the pen, and the position coordinate is detected based on the calculated angle using the principal of triangulation. Accordingly, the problem of the false detection of the position of a light blocking object due to the undesired reflection light as above mentioned may be generated also in the retroreflective type touch panel.

Needless to say, even in such a retroreflective type touch panel, the problem of the false detection of the position of a light blocking object can be solved with the methods described in Embodiments 1 and 2.

In the above description, although the present invention is described by taking a case as an example where the problem of the false detection of the position of a light blocking object is generated in the bezel part 8 on which the light emitting devices 911 are positioned, the present invention is not restricted to the case. Needless to say, the present invention can be applied to a problem of the false detection of the position of a light blocking object in the bezel part 8 on which the light receiving devices 921 are positioned.

In Embodiment 1 of the present invention, a touch panel device which comprises a display panel displaying an image, an array of light emitting devices emitting light along a display screen of the display panel, and an array of light receiving devices disposed opposite to the array of light emitting devices, the light receiving devices receiving light from the light emitting devices, and which detects a position of a light blocking object which shields light from the light emitting devices on the display screen, comprising a holding member which covers a border of the display screen, and holds the display panel, wherein the holding member is provided with an antireflection part which suppresses light emitted from the light emitting devices being reflected and received by the light receiving devices.

According to the present invention, the antireflection part is provided at the holding member that covers the border of the display screen and holds the display panel so as to prevent light emitted from the light emitting devices and directed to the holding member from being reflected and returned to a direction along the display screen.

In Embodiment 2 of the present invention, the touch panel device according to claim 1, wherein the holding member includes a light absorption film which absorbs light emitted from the light emitting devices.

According to the present invention, the antireflection part is configured by providing the light absorption film which absorbs light on the holding member, and light emitted from the light emitting devices and directed to the holding member is absorbed by the light absorption film.

In Embodiment 3 of the present invention, the touch panel device according to claim 2, wherein the holding member is provided with the light absorption film at a portion irradiated with light emitted from the light emitting devices.

According to the present invention, the antireflection part is configured in such a manner that the light absorption film which absorbs light is provided on a portion of the holding member irradiated with light emitted from the light emitting devices, and the light emitted from the light emitting devices and directed to the holding member is absorbed by the light absorption film.

In Embodiment 4 of the present invention, the touch panel device according to claim 1, wherein a light absorption sheet which absorbs light is provided on an end portion of the holding member at the display screen side and at a display screen around the end portion.

According to the present invention, the antireflection part is configured in such a manner that the light absorption sheet which absorbs light is provided on an end portion of the holding member at the display screen side and at the display screen around the edge portion, and the light emitted from the light emitting devices and directed to the holding member is absorbed by the light absorption sheet.

In Embodiment 5 of the present invention, the touch panel device according to claim 1, wherein the holding member is provided with a light absorption sheet which absorbs light at a portion irradiated with light emitted from the light emitting devices.

According to the present invention, the antireflection part is configured in such a manner that the light absorption sheet which absorbs light is provided on a portion of the holding member irradiated with light emitted from the light emitting devices, and the light emitted from the light emitting devices and directed to the holding member is absorbed by the light absorption sheet.

In Embodiment 6 of the present invention, the touch panel device according to claim 1, wherein a slant plane forming an obtuse angle with respect to the display screen is formed at a portion of the holding member irradiated with light emitted from the light emitting devices.

According to the present invention, the antireflection part is configured in such a manner that the slant plane forming an obtuse angle to the display screen is formed on a portion of the holding member irradiated with light emitted from the light emitting devices, and light emitted from the light emitting devices and directed to the holding member is prevented from being reflected and returned to a direction along the display screen by the slant plane.

As this description may be embodied in several forms without departing from the spirit of essential characteristics thereof, the present embodiment is therefore illustrative and not restrictive, since the scope is defined by the appended claims rather than by the description preceding them, and all changes that fall within metes and bounds of the claims, or equivalence of such metes and bounds thereof are therefore intended to be embraced by the claims.

What is claimed is:

1. A touch panel device which comprises a display panel displaying an image, an array of light emitting devices emitting light along a display screen of the display panel, and an array of light receiving devices disposed opposite to the array of light emitting devices, the light receiving devices receiving light from the light emitting devices, and which detects a position of a light blocking object which shields light from the light emitting devices on the display screen, comprising
a holding member which covers a border of the display screen, and holds the display panel, wherein
the holding member is provided with an antireflection part which suppresses light emitted from the light emitting devices being reflected and received by the light receiving devices.

2. The touch panel device according to claim 1, wherein
the holding member includes a light absorption film which absorbs light emitted from the light emitting devices.

3. The touch panel device according to claim 2, wherein
the holding member is provided with the light absorption film at a portion irradiated with light emitted from the light emitting devices.

4. The touch panel device according to claim 1, wherein
a light absorption sheet which absorbs light is provided on an end portion of the holding member whose side is close to the display screen and on a portion of the display screen close to the end portion.

5. The touch panel device according to claim 1, wherein
the holding member is provided with a light absorption sheet which absorbs light at a portion irradiated with light emitted from the light emitting devices.

6. The touch panel device according to claim 1, wherein
a slant plane forming an obtuse angle with respect to the display screen is formed at a portion of the holding member irradiated with light emitted from the light emitting devices.

7. The touch panel device according to claim 2, wherein
the light absorption film contains chlorophyl.

8. The touch panel device according to claim 4, wherein
the light absorption sheet contains chlorophyl.

9. The touch panel device according to claim 5, wherein
the light absorption sheet contains chlorophyl.
